(19) United States
(12) Patent Application Publication
(10) Pub. No.: US 2009/0192824 A1
(43) Pub. Date: Jul. 30, 2009

(54) MEDICAL INFORMATION SYSTEM AND MEDICAL IMAGE STORAGE APPARATUS

(75) Inventors: Maki MINAKUCHI, Otawara-shi (JP); Kenichi Niwa, Otawara-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-shi (JP)

(21) Appl. No.: 12/358,637

(22) Filed: Jan. 23, 2009

(30) Foreign Application Priority Data
Jan. 28, 2008 (JP) 2008-016527

(51) Int. Cl. G06Q 50/00; G06Q 10/00

(52) U.S. Cl. 705/3

(57) ABSTRACT

When a medical image diagnostic apparatus captures a medical image, a medical image storage apparatus retrieves a medical image similar to the captured medical image from among medical images stored in a data storage unit. The medical image storage apparatus collects a past diagnostic reading report that uses the retrieved medical image as a key image or information related to a case, and displays the collected diagnostic reading report or information related to the case.

### CROSS-REFERENCE TO RELATED APPLICATIONS

This application is based upon and claims the benefit of priority from the prior Japanese Patent Application No. 2008-16527, filed on Jan. 28, 2008; the entire contents of which are incorporated herein by reference.

### BACKGROUND OF THE INVENTION

1. Field of the Invention

The present invention relates to a medical information system and a medical image storage apparatus. In particular, the present invention relates to a medical information system and a medical image storage apparatus facilitating acquisition of past diagnostic reading reports and case information used as reference, when a medical image is read and a conference and the like is held.

2. Description of the Related Art

Conventionally, medical information systems are known in which a medical image storage apparatus that stores medical images and a report creation assisting apparatus that assists creation of diagnostic reading reports are connected by a network. Among the medical information systems, some systems provide functions for providing case information used in conferences (meetings for examining test results) and the like, based on a diagnosis in the diagnostic reading report.

In relation to such medical information systems, when a medical image is captured through use of a medical image diagnostic apparatus, imaging conditions of a current imaging operation are often set with reference to imaging conditions of previous imaging operations. When a diagnostic reading report is created through use of a diagnostic reading report creation assisting apparatus, the diagnostic reading report is often created with reference to diagnostic reading reports similar to present test results. In a conference, test results are often examined with reference to pieces of similar case information.

Therefore, a medical information system is proposed (refer to, for example, JP-A 2007-167634 (KOKAI)) in which, for example, when an imaging operation and diagnostic reading are performed, a common object is generated and stored. The stored common object can then be used in subsequent imaging operations and diagnostic readings. The common object includes pieces of information useful for subsequent imaging operations and diagnostic readings as extra information. The pieces of information are, for example, information related to imaging conditions and a key image (an image considered particularly valuable among the captured medical images).

However, the diagnostic reading reports and pieces of case information that are created in the past are enormous in volume. Therefore, even when the above-described conventional technology is used, finding a diagnostic reading report and case information similar to the present test results is ordinarily extremely difficult. For example, a doctor, such as an intern, who has little experience in creating diagnostic reading reports wishes to reference diagnostic reading reports and case information that are created in the past, when creating a diagnostic reading report. However, finding similar diagnostic reading reports and case information is extremely time-consuming. The doctor often ultimately abandons search for the diagnostic reading reports and case information.

### SUMMARY OF THE INVENTION

According to one aspect of the present invention, a medical information system includes an image retrieving unit that retrieves a medical image similar to a certain medical image from among medical images stored by a medical image storage apparatus; a medical information collecting unit that collects a past diagnostic reading report or information related to a case that is related to the medical image retrieved by the image retrieving unit; and a medical information displaying unit that displays the diagnostic reading report or the information related to the case collected by the medical information collecting unit.

According to another aspect of the present invention, a medical information apparatus includes an image retrieving unit that retrieves a medical image similar to a certain medical image from among medical images stored in a storage unit; and a medical information collecting unit that collects a past diagnostic reading report or information related to a case that is related to the medical image retrieved by the image retrieving unit.

### BRIEF DESCRIPTION OF THE DRAWINGS

FIG. 1 is an explanatory diagram of an overview of a medical image diagnostic system according to an embodiment;

FIG. 2 is a functional block diagram of a configuration of a medical image diagnostic apparatus according to the embodiment;

FIG. 3 is a diagram of an example of a common object;

FIG. 4 is a functional block diagram of a configuration of a medical image storage apparatus according to the embodiment;

FIG. 5 is a diagram of an example of an image-related information table;

FIG. 6 is a diagram of an example of a diagnostic result information table;

FIG. 7 is a functional block diagram of configurations of a report creation assisting apparatus and a medical image observing apparatus;

FIG. 8 is a sequence diagram of a flow of processes performed in the medical image diagnostic system according to the embodiment; and

FIG. 9 is a diagram of a flow of processes performed by the medical image storage apparatus according to the embodiment.

### DETAILED DESCRIPTION OF THE INVENTION

Exemplary embodiments of the present invention are below described with reference to the attached drawings. Hereinafter, a medical image diagnostic system will be described in which a medical image diagnostic apparatus and a medical image observing apparatus are further connected to a medical information system according to the present invention.

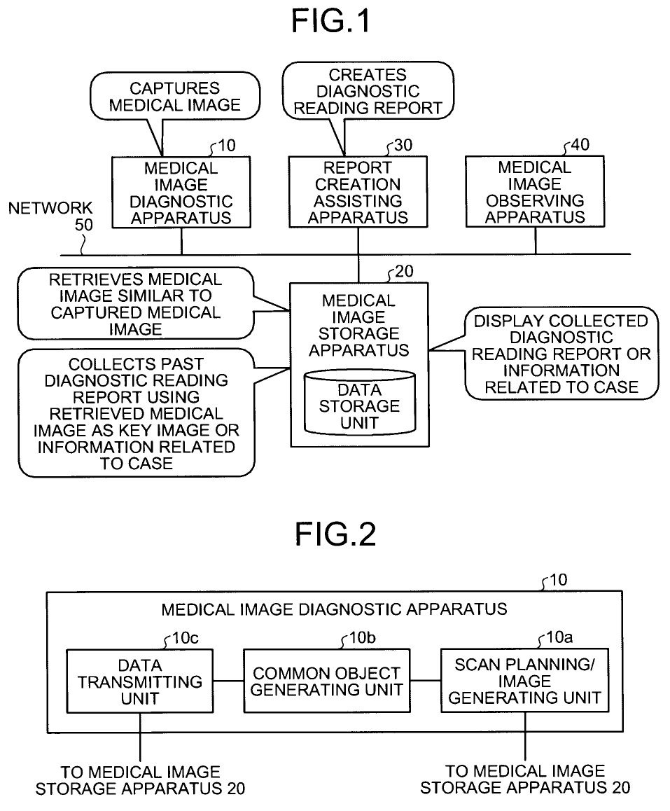

First, an overview of a medical image diagnostic system according to an embodiment will be described. FIG. 1 is an explanatory diagram of the overview of the medical image diagnostic system according to the embodiment. The medical image diagnostic system includes a medical image diagnostic apparatus 10, a medical image storage apparatus 20, a report creation assisting apparatus 30, and a medical image observing apparatus 40 that are connected by a network 50.

The medical image diagnostic apparatus 10 is a modality, such as an X-ray computed tomography (CT) apparatus or a magnetic resonance imaging (MRI) apparatus. The medical image diagnostic apparatus 10 captures a medical image of a subject during an examination. The medical image storage apparatus 20 stores the medical image captured by the medical image diagnostic apparatus 10 in a predetermined data storage unit. The report creation assisting apparatus 30 assists creation of a diagnostic reading report based on the medical image stored by the medical image storage apparatus 20. The medical image observing apparatus 40 displays the medical image stored by the medical image storage apparatus 20 in response to a request from an operator.

Based on a configuration such as this, in the medical image diagnostic system according to the embodiment, when the medical image diagnostic apparatus 10 captures a medical image, the medical image storage apparatus 20 retrieves a medical image similar to the medical image captured by the medical image diagnostic apparatus 10 from medical images stored in the data storage unit. The medical image storage apparatus 20 collects past diagnostic reading reports using the retrieved medical image as a key image or pieces of information related to a case, and displays the collected diagnostic reading reports or information related to the case.

In the medical image diagnostic system, even when the diagnostic reading reports and pieces of case information that are created in the past are enormous in volume, the diagnostic reading reports using key images similar to a key image captured during a present examination and the pieces of case information are automatically collected based on the key image captured during the present examination. Therefore, in the medical image diagnostic system according to the embodiment, when a medical image is read, or when a conference and the like is held, the past diagnostic reading reports and the pieces of case information to be used as references can be easily acquired.

Next, a configuration of the medical image diagnostic apparatus 10 according to the embodiment will be described. FIG. 2 is a functional block diagram of the configuration of the medical image diagnostic apparatus 10 according to the embodiment. The medical image diagnostic apparatus 10 includes, as functional units related to the present invention, a scan planning/image generating unit 10a, a common object generating unit 10b, and a data transmitting unit 10c.

The scan planning/image generating unit 10a captures the medical image of the subject. Specifically, the scan planning/image generating unit 10a acquires a past common object related to the subject to be examined from the medical image storage apparatus 20, in response to an instruction from the operator. The scan planning/image generating unit 10a displays imaging condition information included in extra information of the acquired common object in a display device and the like, and receives settings for a scan plan.

Then, when the operator sets imaging conditions based on the displayed imaging condition information, the scan planning/image generating unit 10a scans the subject in adherence to the set imaging conditions and generates the medical image of the subject. The medical image generated herein is generated as image data in Digital Imaging and Communications in Medicine (DICOM) format.

The common object generating unit 10b generates a common object based on the medical image generated by the scan planning/image generating unit 10a and the imaging conditions set by the operator. The common object is generated as a body of information (such as file) separated from the image data in the DICOM format, described above.

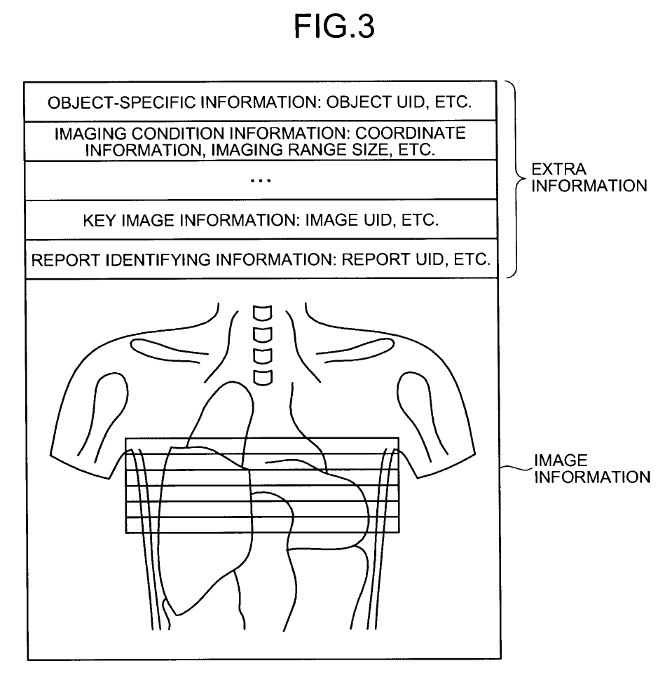

FIG. 3 is a diagram of an example of the common object. For example, the common object includes image information and extra information. In the image information, a positioning image is set as reference for an imaging position or an imaging range. In the extra information, “object-specific information”, “imaging condition information”, “key image information”, “report identifying information”, and the like are set. The “object-specific information” includes an object unique identifier (UID) used to uniquely identify the common object. The “imaging condition information” includes coordinate information, a size of an imaging range, and the like. The “key image information” includes an image UID set during diagnostic reading. The “report identifying information” includes a report UID set during diagnostic reading.

In the common object, the “object-specific information” and the “imaging condition information” in the extra information are set at a timing generated by the common object generating unit 10b. However, the “key image information” and the “report identifying information” are set or updated at a timing at which the report creation assisting apparatus 30, described hereafter, transmits diagnostic result information to the medical image storage apparatus 20, when a diagnostic reading report of the medical image is created. The “key image information” and the “report identifying information” are set or updated by the medical image storage apparatus 20 based on diagnostic result information.

The data transmitting unit 10c transmits the medical image generated by the scan planning/image generating unit 10a and the common object generated by the common object generating unit 10b to the medical image storage apparatus 20.

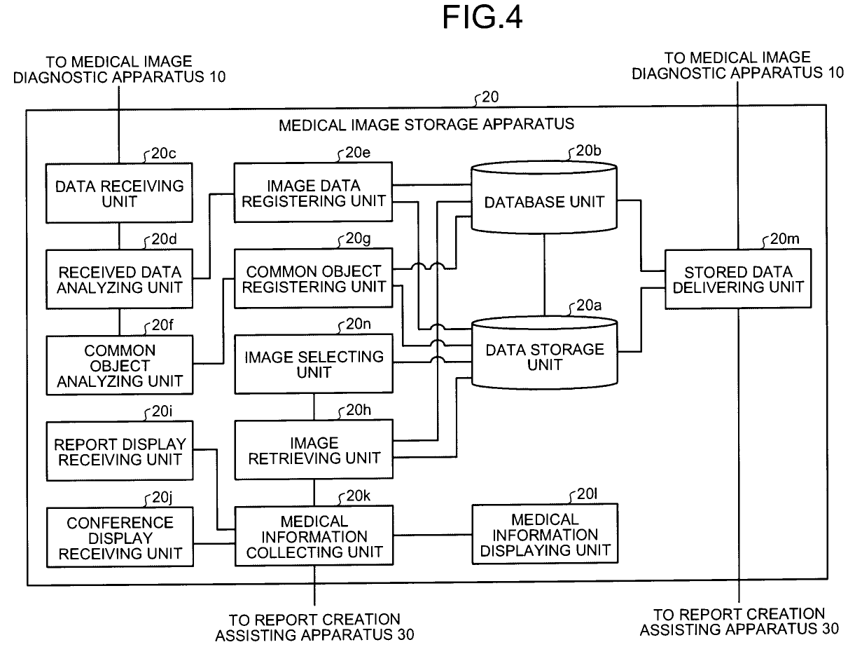

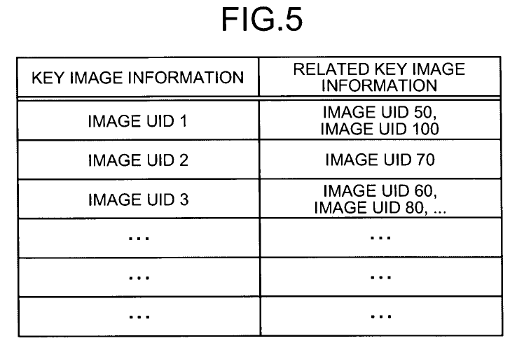

Next, a configuration of the medical image storage apparatus 20 according to the embodiment will be described. FIG. 4 is a functional block diagram of the configuration of the medical image storage apparatus 20. The medical image storage apparatus 20 includes a data storage unit 20a, a database unit 20b, a data receiving unit 20c, a received data analyzing unit 20d, an image data registering unit 20e, a common object analyzing unit 20f, a common object registering unit 20g, an image retrieving unit 20h, a report display receiving unit 20i, a conference display receiving unit 20j, a medical information collecting unit 20k, a medical information displaying unit 20l, a stored data delivering unit 20m, an image selecting unit 20n.

The data storage unit 20a stores therein pieces of image data and common objects transmitted from the medical image diagnostic apparatus 10. When the data storage unit 20a newly stores or modifies a piece of image data or a common object, the data storage unit 20a communicates with the database unit 20b, described hereafter, and sends management information, such as a location at which the data is saved or a modification made to the data, to the database unit 20b. The data storage unit 20a is actualized by a hard disk drive (HDD) or a network attached storage (NAS). The data storage unit 20a can also be provided outside of the medical image storage apparatus 20.

The database unit 20b stores therein various pieces of management information. For example, the database unit 20b stores therein pieces of management information related to the pieces of image data and the common objects stored by the data storage unit 20a. When the data storage unit 20a sends management information, such as the location at which a piece of data is stored or a modification made to a piece of data, the database unit 20b stores the management information and also sends a registration notification for the medical image to the image retrieving unit 20h, described hereafter. The database unit 20b also stores therein an image-related information table and a diagnostic result information table, as information related to the present invention.

FIG. 5 is a diagram of an example of the image-related information table. For example, in the image-related information table, key image information and related key image information are associated and stored. Here, an image UID is set as the key image information. The image UID uniquely identifies image data of a medical image. An image UID of image data similar to the image data of the image UID set as the key image information is set as the related key image information. The image-related information table is created by the image retrieving unit 20h at a timing at which the above-described registration notification for the medical image is sent from the database unit 20b to the image retrieving unit 20h.

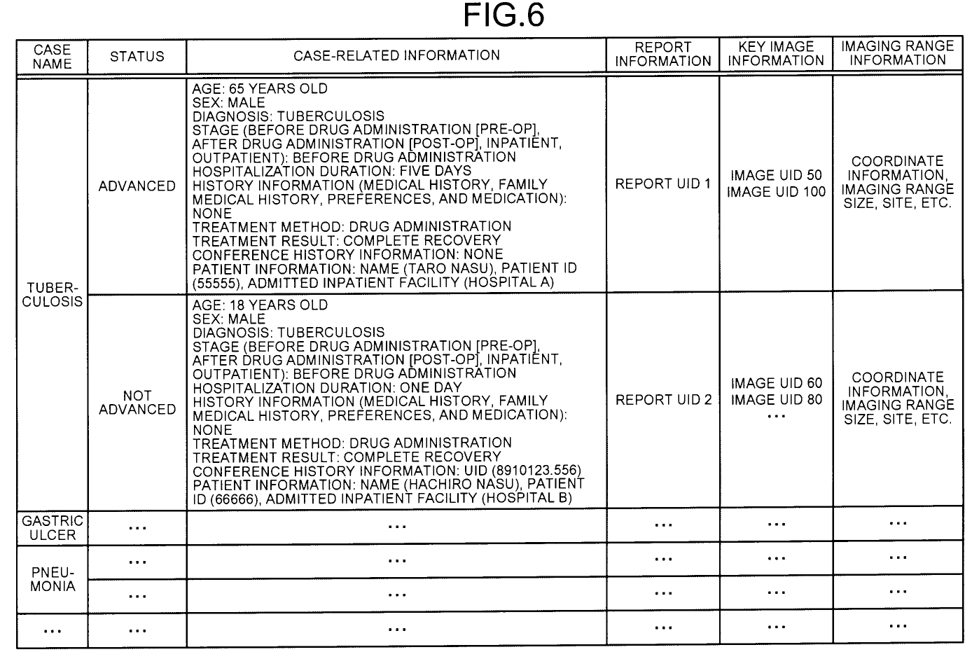

FIG. 6 is a diagram of an example of the diagnostic result information table. For example, in the diagnostic result information table, a case name, status, case-related information, report information, key image information, and imaging range information are each associated and stored. Here, a name indicating the case, such as “tuberculosis”, “gastric ulcer”, and “pneumonia”, is set as the case name. A name indicating the symptoms, such as “advanced” and “not advanced”, are set as the status.

As the case-related information, pieces of information related to the case are set, such as age and sex, diagnosis, stage, duration of hospitalization, history information, treatment method, treatment result, conference history information, and patient information. As the report information, the report UID uniquely attached to each diagnostic reading report when the diagnostic reading report is created is set.

As the key image information, the image UID of the image data used as the key image in the diagnostic reading report of the report UID set as the report information is set. As the imaging range information, information related to the imaging range are set, such as the coordinate information of when an imaging operation is performed, the size of the imaging range, and an imaged site.

The diagnostic result information table is set or updated at the timing at which the diagnostic result information is transmitted from the report creation assisting apparatus 30, described hereafter, when the diagnostic reading report of the medical image is created. The diagnostic result information table is set or updated by the stored data delivering unit 20m, described hereafter, based on the diagnostic result information.

The data receiving unit 20c receives the image data and the common object transmitted from the medical image diagnostic apparatus 10. Upon receiving the image data and the common object, the data receiving unit 20c sends the received image data and common object to the received data analyzing unit 20d, described hereafter.

The received data analyzing unit 20d analyzes the image data and the common object received by the data receiving unit 20c and assigns the image data and the common object to appropriate processing units. Specifically, when the image data and the common object is sent from the data receiving unit 20c, the received data analyzing unit 20d sends the image data to the image data registering unit 20e, described hereafter, and sends the common object to the common object analyzing unit 20f, described hereafter.

The image data registering unit 20e registers the image data sent from the received data analyzing unit 20d to the data storage unit 20a and registers the management information related to the image data to the database unit 20b.

The common object analyzing unit 20f analyzes the common object sent from the received data analyzing unit 20d and extracts information that serves as the management information from the common object.

The common object registering unit 20g registers the common object analyzed by the common object analyzing unit 20f to the data storage unit 20a and registers the information extracted from the common object by the common object analyzing unit 20f to the database unit 20b.

The image selecting unit 20n selects a characteristic medical image from among the medical images. Specifically, when the image selecting unit 20n is instructed by the image retrieving unit 20h, described hereafter, to select a medical image to serve as a candidate for the key image, the image selecting unit 20n extracts the medical images captured during the present examination from among the medical images stored in the data storage unit 20a. The image selecting unit 20n then selects the characteristic medical image from within the extracted medical images as the candidate for the key image.

Here, the image selecting unit 20n automatically selects the candidate for the key image using, for example, a method such as feature extraction and time-lapse difference calculation, feature amount analysis, and extraction of medical images having similar image positions or imaging ranges, using a known computer-aided design (CAD) function and the like. Alternatively, rather than automatically selecting the candidate for the key image, the image retrieving unit 20h can display the medical images captured during the present examination and receive designation of the key image from the operator.

The image retrieving unit 20h retrieves a medical image similar to a certain medical image from among the medical images stored in the data storage unit 20a. Specifically, when the registration notification for the medical image is sent from the database unit 20b, the image retrieving unit 20h first instructs the image selecting unit 20n to select the medical image to serve as the candidate for the key image.

Then, when the image selecting unit 20n selects the candidate for the key image, the image retrieving unit 20h retrieves image data with a high degree of similarity with the candidate for key image by comparing the selected candidate for the key image with the image data stored in the data storage unit 20a.

Here, the image retrieving unit 20h retrieves the image data with a high degree of similarity by, for example, evaluating correspondence in feature quantities of contour and color between the pieces of image data, for each area separated into local areas, using a technology, such as known feature extraction and feature amount analysis methods (comparison of histograms and the like), and relaxation matching methods.

Specifically, the image retrieving unit 20h evaluates the correspondence in predetermined feature quantities for each medical image stored in the data storage unit 20a, thereby calculating a degree of similarity with the candidate for the key image selected by the image selecting unit 20n. Then, upon ranking each medical image using the calculated degree of similarity, the image retrieving unit 20h retrieves a medical image ranked higher than a predetermined threshold value.

The image retrieving unit 20h then associates the key image information and the related key image information. The image UID of the candidate for the key image selected by the image selecting unit 20n or the designated key image serves as the key image information. The image UID of the retrieved image data serves as the related key image information. The image retrieving unit 20h registers the associated key image information and related key image information to the image-related information table stored in the database unit 20b. As a result, the image-related information table stored in the database unit 20b is updated to a newest state. The image-related information table can be collectively updated by, for example, batch processing and the like performed at night, in consideration of load placed on the device.

Moreover, the image retrieving unit 20h references the diagnostic result information table stored in the data storage unit 20a or the extra information of the common object based on the image UID of the retrieved image data, and acquires the report UID of a past diagnostic reading report corresponding to the image UID and information (such as the case name, the status, the case-related information, and the imaging range information) related to the case.

Then, the image retrieving unit 20h sends the image data of the candidate for the key image selected by the image selecting unit 20n or the designated key image, and the acquired report UID and information related to the case to the medical information collecting unit 20k, described hereafter. The image data, the report UID, and the information related to the case sent herein is used in the medical information collecting unit 20k, described hereafter, when medical information is collected.

The report display receiving unit 20i receives a display request for information related to diagnostic reading. The report display receiving unit 20i receives the display request for the information related to the diagnostic reading from the operator, such as a doctor performing a diagnostic reading, via an input device (not shown) such as a mouse or a keyboard.

The conference display receiving unit 20j receives a display request for information related to a conference. The conference display receiving unit 20j receives the display request for the information related to the conference from the operator, such as a doctor in attendance, through an input device (not shown) such as a mouse or a keyboard.

The medical information collecting unit 20k collects related past diagnostic reading reports or information related to the case that are related to the medical images retrieved by the image retrieving unit 20h. Specifically, when the image retrieving unit 20h sends the image data of the candidate for key image or the key image, the medical information collecting unit 20k instructs the medical information displaying unit 20l, described hereafter, to display the image data.

When the report display receiving unit 20i receives the display request for the information related to the diagnostic reading report, the medical information collecting unit 20k requests from the report creation assisting apparatus 30, described hereafter, information related to the diagnostic reading report corresponding to the report UID sent from the image retrieving unit 20h. Then, when the report creation assisting apparatus 30 responds with the information related to the diagnostic reading report, the medical information collecting unit 20k instructs the medical information displaying unit 20l, described hereafter, to display the information.

When the conference display receiving unit 20j received the display request for the information related to the conference, the medical information collecting unit 20k instructs the medical information displaying unit 20l, described hereafter, to display the information related to the case sent from the image retrieving unit 20h.

Moreover, when instructing the medical information displaying unit 20l to display the image data to serve as the candidate for the key image, the information related to the diagnostic reading report or the information related to the case, the medical information collecting unit 20k stores the image data and the information in an internal memory.

A medical information displaying unit 20l displays the diagnostic reading report or the information related to the case collected by the medical information collecting unit 20k. Specifically, when the medical information collecting unit 20k instructs the medical information displaying unit 20l to display the image data of the candidate for the key image, the diagnostic reading report, or the information related to the case, the medical information displaying unit 20l displays the image data or the information in a display device (not shown), such as a liquid crystal display.

Here, as a result of the medical information displaying unit 20l displaying the medical image selected by the image selecting unit 20n as the candidate for the key image, a doctor who has little experience in performing a diagnostic reading, such as an intern, can easily find the candidate for the key image.

Moreover, when a plurality of pieces of information related to the diagnostic reading report indicated by the medical information collecting unit 20k are present, the pieces of information can be listed and displayed as a list of reference reports. Then, when the operator selects a diagnostic reading report from the list, the medical information displaying unit 20l displays only the selected diagnostic reading report.

The stored data delivering unit 20m delivers the pieces of information stored in the data storage unit 20a and the database unit 20b to a request source, in response to a request transmitted from another device. The stored data delivering unit 20m also updates the pieces of information stored in the data storage unit 20a and the database unit 20b based on information transmitted from other devices.

Specifically, when the medical image diagnostic apparatus 10 requests a common object, the stored data delivering unit 20m references the data storage unit 20a and the database unit 20b, and delivers the requested common object to the medical image diagnostic apparatus 10. When the report creation assisting apparatus 30, described hereafter, requests a piece of image data of a medical image, the stored data delivering unit 20m references the data storage unit 20a and the database unit 20b and delivers the requested piece of image data to the report creation assisting apparatus 30.

When the report creation assisting apparatus 30 transmits the diagnostic result information, the stored data delivering unit 20m updates the key image information and the report identifying information included in the extra information of the common object stored in the data storage unit 20a, based on the transmitted diagnostic result information. The stored data delivering unit 20m also respectively updates the case-related information, the report information, the key image information, and the imaging range information included in the diagnostic result information table stored in the database unit 20b.

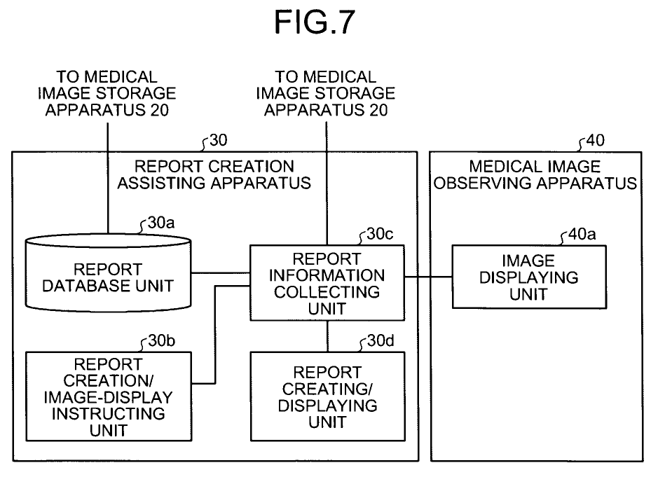

Next, configurations of the report creation assisting apparatus 30 and the medical image observing apparatus 40 will be described. FIG. 7 is a functional block diagram of the configurations of the report creation assisting apparatus 30 and the medical image observing apparatus 40. The report creation assisting apparatus 30 includes, as functional units related to the present invention, a report database unit 30a, a report creation/image-display instructing unit 30b, a report information collecting unit 30c, and a report creating/displaying unit 30d.

The report database unit 30a stores therein information related to the diagnostic reading report created when the medical image is read.

The report creation/image-display instructing unit 30b receives a diagnostic reading report creation preparation request and a medical image display request from the operator, such as a doctor performing the diagnostic reading, through an input device (not shown), such as a mouse or a keyboard. When each request is received, the report creation/image-display instructing unit 30b instructs the report information collecting unit 30c, described hereafter, to prepare for diagnostic reading report creation and display the medical image.

The report information collecting unit 30c collects the information related to the diagnostic reading report and the image data of the medical image. Specifically, when the report creation/image-display instructing unit 30b instructs the report information collecting unit 30c to prepare for diagnostic reading report creation, the report information collecting unit 30c instructs the report creating/displaying unit 30d, described hereafter, to display a report creation preparation screen.

Then, the report information collecting unit 30c acquires the image data to serve as the candidate for the key image and the information from the internal memory, and instructs the report creating/displaying unit 30d to display the acquired image data and the acquired information.

When the operator instructs the report information collecting unit 30c to display the information related to the diagnostic reading report via the report creation/image-display instructing unit 30b, the report information collecting unit 30c acquires the information related to a specified diagnostic reading report from the report database unit 30a and instructs the report creating/displaying unit 30d, described hereafter, to display the acquired information.

When the report information collecting unit 30c receives input of the information related to the diagnostic reading report from the operator via the report creation/image-display instructing unit 30b, the report information collecting unit 30c stores the received input information in the report database unit 30a and transmits the diagnostic result information included in the information to the medical image storage apparatus 20.

The diagnostic result information transmitted herein includes the report UID of the created diagnostic reading report, the image UID of the key image used in the diagnostic reading report, the case-related information (such as age and sex, diagnosis, stage, duration of hospitalization, history information, treatment method, treatment result, conference history information, and patient information), and the imaging range information (such as coordinate information of when the imaging operation is performed, the size of the imaging range, and the imaged site).

When the report information collecting unit 30c is instructed via the report creation/image-display instructing unit 30b to display the medical image, the report information collecting unit 30c acquires the image data of the designated medical image and transmits the acquired image data to the medical image observing apparatus 40, described hereafter.

A report creating/displaying unit 30f displays the report creation preparation screen and the information related to the diagnostic reading report in a display device (not shown) and the like, such as a liquid crystal display included in the report creation assisting apparatus 30, based on the instruction from the report information collecting unit 30c.

On the other hand, the medical image observing apparatus 40 includes an image displaying unit 40a as a related functional unit. The image displaying unit 40a displays the image data transmitted from the report creation assisting apparatus 30 in a display device (not shown), such as a liquid crystal display included in the medical image observing apparatus 40.

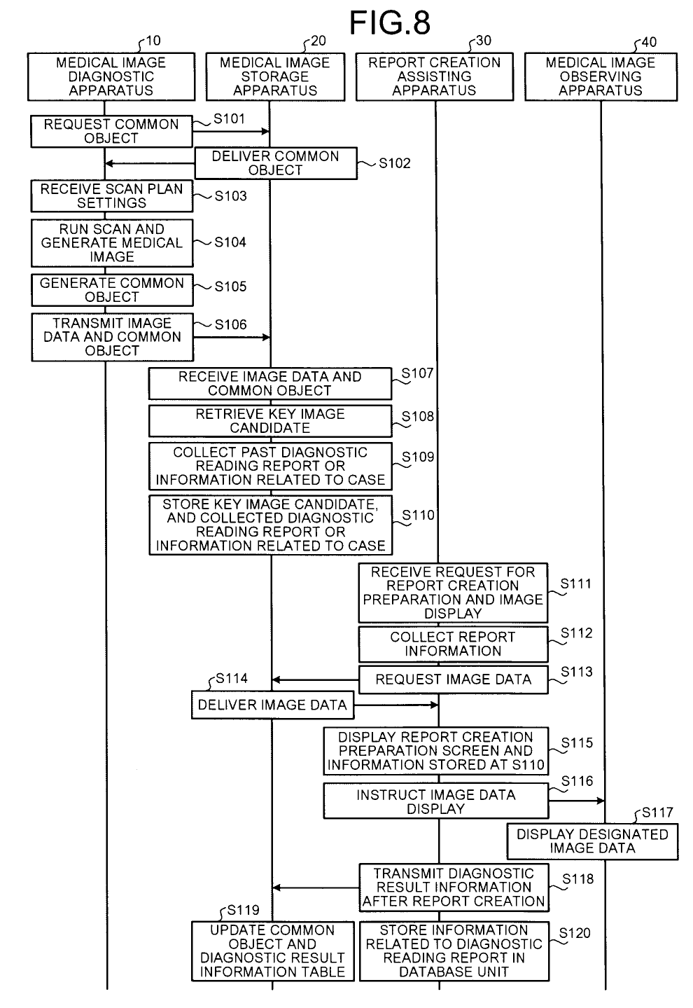

Next, a flow of processes performed in the medical image diagnostic system according to the embodiment will be described. FIG. 8 is a sequence diagram of the flow of the processes performed in the medical image diagnostic system according to the embodiment. In the medical image diagnostic system, first, when the medical image of the subject is captured, the medical image diagnostic apparatus 10 requests a common object from the medical image storage apparatus 20 (Step S101).

When the common object is requested, the medical image storage apparatus 20 acquires the requested common object from the data storage unit 20a and delivers the acquired common object to the medical image diagnostic apparatus 10 (Step S102). When the common object is delivered, the medical image diagnostic apparatus 10 receives settings for a scan plan from the operator (Step S103).

Then, when the operator sets the scan plan, the medical image diagnostic apparatus 10 runs a scan and generates the medical image (Step S104). The medical image diagnostic apparatus 10 also generates the common object (Step S105). The medical image diagnostic apparatus 10 then transmits image data of the generated medical image and the common object to the medical image storage apparatus 20 (Step S106).

When the image data and the common object are received (Step S107), the medical image storage apparatus 20 retrieves the candidate for the key image (Step S108), and collects the past diagnostic reading report or the information related to the case stored in the data storage unit 20a, based on the retrieved key image (Step S109). Then, the medical image storage apparatus 20 displays and stores the candidate for the key image, and the collected diagnostic reading report or information related to the case (Step S110).

Next, when the captured medical image is read, and the report creation assisting apparatus 30 receives the request from the operator, such as a doctor performing the diagnostic reading, to prepare for report creation or display the image, (Step S111), the report creation assisting apparatus 30 collects the information related to the diagnostic reading report (Step S112) and requests the image data from the medical image storage apparatus 20 (Step S113).

When the image data is requested, the medical image storage apparatus 20 acquires the requested image data from the data storage unit 20a and delivers the acquired image data to the report creation assisting apparatus 30 (Step S114). Next, the report creation assisting apparatus 30 displays the report creation preparation screen and displays the information stored at Step S110 (Step S115). Then the report creation assisting apparatus 30 transmits the delivered image data to the medical image observing apparatus 40 (Step S116). When the image data is transmitted, the medical image observing apparatus 40 displays the transmitted image data (Step S117).

Then, when the report creation assisting apparatus 30 receives the input of the information related to the diagnostic reading report from the operator, via the report creation/image-display instructing unit 30b, the report creation assisting apparatus 30 stores the inputted information in the report database unit 30a and transmits the diagnostic result information included in the inputted information to the medical image storage apparatus 20 (Step S118).

When the diagnostic result information is received, the medical image storage apparatus 20 updates the common object stored in the data storage unit 20a and the diagnostic result information table stored in the database unit 20b, based on the received diagnostic result information (Step S119). On the other hand, the report creation assisting apparatus 30 stores the inputted information related to the diagnostic reading report in the report database unit 30a (Step S120).

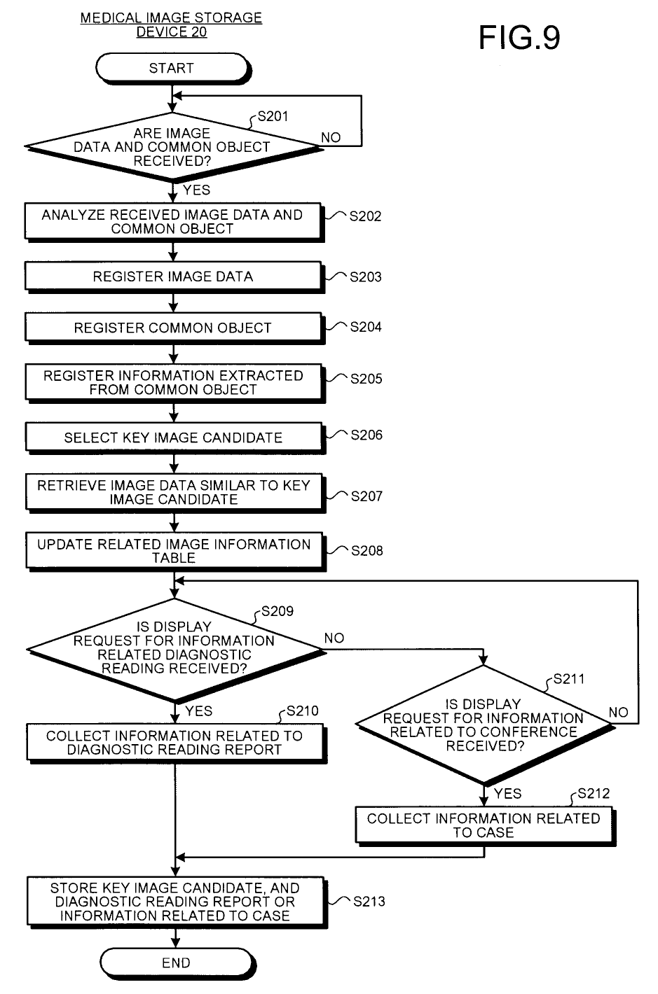

Next, a flow of processes performed by the medical image storage apparatus 20 according to the embodiment will be described. FIG. 9 is a diagram of the flow of the processes performed by the medical image storage apparatus 20 according to the embodiment. The flow of processes described here corresponds to Step S107 to Step S110 in the flow of processes described with reference to FIG. 8.

In the medical image storage apparatus 20, when the data receiving unit 20c receives the image data and the common object (Yes at Step S201), the received data analyzing unit 20d analyzes the received image data and common object (Step S202).

Then, the image data registering unit 20e registers the image data to the data storage unit 20a and the database unit 20b (Step S203). The common object registering unit 20g registers the common object to the data storage unit 20a (Step S204). The common object registering unit 20g also registers the information extracted from the common object by the common object analyzing unit 20f to the database unit 20b (Step S205).

Next, the image selecting unit 20n selects the image data of the characteristic medical image as the candidate for the key image (Step S206). The image retrieving unit 20h then retrieves the image data similar to the candidate for the key image selected by the image selecting unit 20n (Step S207), and updates the related image information table (Step S208).

Next, when the report display receiving unit 20i receives the display request for the information related to the diagnostic reading (Yes at Step S209), the medical information collecting unit 20k collects the information related to the past diagnostic reading report using the medical image retrieved by the image retrieving unit 20h as the key image (Step S210).

On the other hand, when the conference display receiving unit 20j receives the display request for the information related to the conference (Yes at Step S211), the medical information collecting unit 20k collects the information related to past cases using the medical image retrieved by the image retrieving unit 20h as the key image (Step S212).

Then, the medical information displaying unit 20l displays and stores the diagnostic reading report collected by the report display receiving unit 20i or the information related to the case collected by the conference display receiving unit 20j (Step S213).

As described above, according to the embodiment, in the medical image storage apparatus 20, the image retrieving unit 20h retrieves the medical image similar to a certain medical image from among the medical images stored in the data storage unit 20a. The medical information collecting unit 20k collects the past diagnostic reading report or the information related to the case that is related to the medical image retrieved by the image retrieving unit 20h. The medical information displaying unit 20l displays the diagnostic reading report or the information related to the case collected by the medical information collecting unit 20k. Therefore, when a medical image is read, or when a conference and the like is held, the past diagnostic reading reports and the pieces of case information to be used as references can be easily acquired.

According to the embodiment, the report display receiving unit 20i receives the display request for the information related to the diagnostic reading. The medical information collecting unit 20k collects the information related to the diagnostic reading when the report display receiving unit 20i receives the display request for the information related to the diagnostic reading. Therefore, when a medical image is read, the past diagnostic reading reports to be used as reference can be easily acquired.

According to the embodiment, the conference display receiving unit 20j receives the display request for the information related to the conference. The medical information collecting unit 20k collects the information related to the conference when the conference display receiving unit 20j receives the display request for the information related to the conference. Therefore, when a conference is held, the past case information to be used as reference can be easily acquired.

According to the embodiment, the key image selecting unit 20n selects the characteristic medical image from among the medical images. The image retrieving unit 20h retrieves the medical image similar to the medical image selected by the key image selecting unit 20n from among the medical images stored in the medical image storage apparatus 20. Therefore, the medical image similar to the characteristic medical image can be automatically retrieved. The past diagnostic reading reports to be used as reference can be more easily acquired.

According to the embodiment, the key image selecting unit 20n is used when the operator selects a certain medical image. The image retrieving unit 20h retrieves the medical image similar to the key image selected by the key image selecting unit 20n from among the medical images stored in the medical image storage apparatus 20. Therefore, the past diagnostic reading reports to be used as reference can be acquired based on the medical image similar to the medical image judged by the operator to be important.

According to the embodiment, the medical information collecting unit 20k collects the past diagnostic reading report or information related to the case that is related to the medical image retrieved by the image retrieving unit 20h. However, the present invention is not limited thereto. For example, the medical information collecting unit 20k can, in addition to the past diagnostic reading report related to the medical image retrieved by the image retrieving unit 20h, collect a diagnostic reading report including a diagnosis that matches that of the collected past diagnostic reading report.

In this instance, specifically, when the image retrieving unit 20h responds with the information related to the diagnostic reading report corresponding to the report UID sent from the image retrieving unit 20h, the medical information collecting unit 20k extracts the diagnosis from the information. The medical information collecting unit 20k further acquires information on the diagnostic reading report including a diagnosis that matches the extracted diagnosis from the report creation assisting apparatus 30. The medical information collecting unit 20k then instructs the medical information displaying unit 20l to further display the acquired information.

As a result, in addition to the diagnostic reading report retrieved based on the candidate for the key image, a diagnostic reading report including a diagnosis that matches the diagnosis in the retrieved diagnostic reading report can be displayed. Therefore, the diagnostic reading reports provided as reference information when a diagnostic reading report is created can be further increased.

Each constituent element of each device shown according to the embodiment is a functional concept. The constituent elements are not necessarily required to be physically configured as shown in the drawings. In other words, specific aspects of dispersal and integration of each device are not limited to those shown in the drawings. All or some devices can be configured such as to be functionally or physically dispersed or integrated in arbitrary units, based on various loads and usage conditions.

As described above, the medical information system and the medical image storage apparatus of the present invention are useful when a medical image is read and when a conference and the like is held. In particular, the medical information system and the medical image storage apparatus of the present invention are suitable for when past diagnostic reading reports and case information to be used as references are required to be easily acquired.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical information system comprising:
an image retrieving unit that retrieves a medical image similar to a certain medical image from among medical images stored by a medical image storage apparatus;
a medical information collecting unit that collects a past diagnostic reading report or information related to a case that is related to the medical image retrieved by the image retrieving unit; and
a medical information displaying unit that displays the diagnostic reading report or the information related to the case collected by the medical information collecting unit.

2. The system according to claim 1, further comprising:
a report display receiving unit that receives a display request for information related to a diagnostic reading, wherein
the medical information collecting unit collects information related to the diagnostic reading, when the report display receiving unit receives the display request for the information related to the diagnostic reading.

3. The system according to claim 1, further comprising:
a conference display receiving unit that receives a display request for information related to a conference, wherein
the medical information collecting unit collects information related to the conference, when the conference display receiving unit receives the display request for the information related to the conference.

4. The system according to claim 2, further comprising:
a conference display receiving unit that receives a display request for information related to a conference, wherein
the medical information collecting unit collects information related to the conference, when the conference display receiving unit receives the display request for the information related to the conference.

5. The system according to claim 1, further comprising:
an image selecting unit that selects a characteristic medical image from among medical images, wherein
the image retrieving unit retrieves a medical image similar to the medical image selected by the image selecting unit from among medical images stored by the medical image storage apparatus.

6. The system according to claim 2, further comprising:
an image selecting unit that selects a characteristic medical image from among medical images, wherein
the image retrieving unit retrieves a medical image similar to the medical image selected by the image selecting unit from among medical images stored by the medical image storage apparatus.

7. The system according to claim 3, further comprising:
an image selecting unit that selects a characteristic medical image from among medical images, wherein
the image retrieving unit retrieves a medical image similar to the medical image selected by the image selecting unit from among medical images stored by the medical image storage apparatus.

8. The system according to claim 4, further comprising:
an image selecting unit that selects a characteristic medical image from among medical images, wherein
the image retrieving unit retrieves a medical image similar to the medical image selected by the image selecting unit from among medical images stored by the medical image storage apparatus.

9. The system according to claim 1, further comprising:
an image selecting unit for selecting a specific medical image by an operator, wherein
the image retrieving unit retrieves a medical image similar to the medical image selected by the image selecting unit from among medical images stored by the medical image storage apparatus.

10. The system according to claim 2, further comprising:
an image selecting unit for selecting a specific medical image by an operator, wherein
the image retrieving unit retrieves a medical image similar to the medical image selected by the image selecting unit from among medical images stored by the medical image storage apparatus.

11. The system according to claim 3, further comprising:
an image selecting unit for selecting a specific medical image by an operator, wherein
the image retrieving unit retrieves a medical image similar to the medical image selected by the image selecting unit from among medical images stored by the medical image storage apparatus.

12. The system according to claim 4, further comprising:
an image selecting unit for selecting a specific medical image by an operator, wherein
the image retrieving unit retrieves a medical image similar to the medical image selected by the image selecting unit from among medical images stored by the medical image storage apparatus.

13. The system according to claim 1, wherein the image retrieving unit calculates a degree of similarity with the certain medical image based on a predetermined feature amount, for each medical image stored by the medical image storage apparatus, and retrieves a medical image of which the calculated degree of similarity exceeds a predetermined threshold value.

14. The system according to claim 2, wherein the image retrieving unit calculates a degree of similarity with the certain medical image based on a predetermined feature amount, for each medical image stored by the medical image storage apparatus, and retrieves a medical image of which the calculated degree of similarity exceeds a predetermined threshold value.

15. The system according to claim 3, wherein the image retrieving unit calculates a degree of similarity with the certain medical image based on a predetermined feature amount, for each medical image stored by the medical image storage apparatus, and retrieves a medical image of which the calculated degree of similarity exceeds a predetermined threshold value.

16. The system according to claim 4, wherein the image retrieving unit calculates a degree of similarity with the certain medical image based on a predetermined feature amount, for each medical image stored by the medical image storage apparatus, and retrieves a medical image of which the calculated degree of similarity exceeds a predetermined threshold value.

17. The system according to claim 5, wherein the image retrieving unit calculates a degree of similarity with the certain medical image based on a predetermined feature amount, for each medical image stored by the medical image storage apparatus, and retrieves a medical image of which the calculated degree of similarity exceeds a predetermined threshold value.

18. The system according to claim 1, wherein, the medical information collecting unit further collects a diagnostic reading report including a diagnosis that matches a diagnosis in the retrieved diagnostic reading report, in addition to the past diagnostic reading report related to the medical image retrieved by the image retrieving unit.

19. The system according to claim 2, wherein, the medical information collecting unit further collects a diagnostic reading report including a diagnosis that matches a diagnosis in the retrieved diagnostic reading report, in addition to the past diagnostic reading report related to the medical image retrieved by the image retrieving unit.

20. A medical image storage apparatus comprising:
an image retrieving unit that retrieves a medical image similar to a certain medical image from among medical images stored in a storage unit; and
a medical information collecting unit that collects a past diagnostic reading report or information related to a case that is related to the medical image retrieved by the image retrieving unit.
